(19) United States
(12) Patent Application Publication
(10) Pub. No.: US 2026/0285107 A1
(43) Pub. Date: Sep. 24, 2026

(54) Variable-Geometry Suspension Mechanism and Wheel-Side Corner Module for Distributed Drive Electric Commercial Vehicles

(71) Applicant: Jilin University, Changchun (CN)

(72) Inventors: Zhenhai Gao, Changchun (CN); Hanying Zhang, Changchun (CN); Zongzhi Han, Changchun (CN); Guoying Chen, Changchun (CN); Bohua Sun, Changchun (CN); Deping Wang, Changchun (CN)

(21) Appl. No.: 19/388,961

(22) Filed: Nov. 13, 2025

(30) Foreign Application Priority Data
Mar. 18, 2025 (CN) 202510314954.8

(51) Int. Cl. B60G 3/26; B60G 3/20; B60G 7/00; B60G 7/02; B60G 13/00; B60K 7/00; B62D 5/04; B62D 17/00; B62D 33/02

(52) U.S. Cl. CPC B60G 3/26; B60G 3/20; B60G 7/008; B60G 7/02; B60G 13/003; B60G 13/005; B60K 7/0007; B62D 5/0403; B62D 17/00; B62D 33/02; B60G 2200/144; B60G 2202/42; B60G 2204/143; B60G 2204/148; B60G 2204/41

(57) ABSTRACT

The present application relates to the technical field of suspension mechanisms, and provides a variable-geometry suspension mechanism and a wheel-side corner module for distributed drive electric commercial vehicles. The suspension mechanism includes a supporting frame, an upper control arm assembly, a first servo electric cylinder, a second servo electric cylinder, and a shock absorber; one end of the upper control arm assembly is hinged to a drive-brake integrated structure, and the other end is hinged to the vehicle frame; the first servo electric cylinder and the second servo electric cylinder function as lower control arms of the suspension and as driving units for steering and cambering motions; one end of each of the first servo electric cylinder and the second servo electric cylinder is hinged to the drive-brake integrated structure, and the other end is hinged to the vehicle frame.

### CROSS-REFERENCE TO RELATED APPLICATIONS

This application claims priority to Chinese Patent Application No. 202510314954.8, filed on Mar. 18, 2025, which is hereby incorporated by reference in its entirety.

### TECHNICAL FIELD

The present application belongs to the technical field of suspension mechanisms, and particularly relates to a variable-geometry suspension mechanism and a wheel-side corner module for distributed drive electric commercial vehicles.

### BACKGROUND

A modular distributed drive electric commercial vehicle provides an effective means to improve the flexibility and efficiency of transport tasks through the integration of various transportation requirements. A wheel-corner module, which integrates the driving, braking, steering, and suspension systems, brings significant changes to the layout of a distributed drive electric chassis compared with a conventional chassis: (1) The in-wheel motor and independent steering system release the wheels from mechanical constraints, thereby enabling chassis designs with high maneuverability and multiple degrees of freedom. (2) The integration of various chassis subsystems within a limited space imposes strict constraints on the arrangement of actuators and the envelope of wheel motion.

A suspension mechanism, as the core of chassis modular design and system integration, plays an important role in extending the stability boundary and motion modes of distributed drive electric commercial vehicles. The existing suspension mechanism within a corner module mostly adopts conventional independent suspension forms, such as double wishbone suspension, trailing arm suspension, MacPherson suspension, and candle-type suspension, which makes it difficult to improve the degree of system integration and performance boundary. In addition, the integration of the in-wheel motor and steering actuator causes significant changes in the hardpoint layout of the suspension, thereby deteriorating the geometric kinematic performance of the suspension.

At present, both domestic and foreign studies on the configuration of wheel-side corner modules mainly focus on passenger vehicles, while little attention has been paid to the influence of large loads and complex driving conditions of commercial vehicles on the corner module and suspension configuration design.

### SUMMARY

An objective of embodiments of the present application is to provide a variable-geometry suspension mechanism and a wheel-side corner module for distributed drive electric commercial vehicles, so as to solve the problems in the background.

The embodiment of the present application is implemented as follows: a variable-geometry suspension mechanism for distributed drive electric commercial vehicles is provided. The variable-geometry suspension mechanism is configured to connect a wheel to a vehicle frame of the distributed drive electric commercial vehicle, and includes: a supporting frame, an upper control arm assembly, a first servo electric cylinder, a second servo electric cylinder, and a shock absorber;

the upper control arm assembly includes a first control arm, a second control arm, and a third control arm, and is located on one side of the supporting frame; one end of the upper control arm assembly is hinged to a drive-brake integrated structure, and the other end of the upper control arm assembly is hinged to the vehicle frame;

the first servo electric cylinder and the second servo electric cylinder function as lower control arms of the suspension and as driving units for steering and cambering motions; one end of each of the first servo electric cylinder and the second servo electric cylinder is hinged to the drive-brake integrated structure, and the other end of each of the first servo electric cylinder and the second servo electric cylinder is hinged to the vehicle frame; and

one end of the shock absorber is hinged to the third control arm, and the other end of the shock absorber is hinged to the vehicle frame.

Further, the variable-geometry suspension mechanism for distributed drive electric commercial vehicles also includes a first bushing and a second bushing, both of which are elastic elements;

one end of the first control arm is hinged to a sixth mounting seat on the supporting frame via a first mounting hole and the first bushing, and the other end of the first control arm is hinged to the vehicle frame via a second mounting hole and the second bushing; and

the second control arm is connected in the same manner as the first control arm.

Further, a topology of the suspension mechanism is a PaU-2UPU configuration, and the PaU-2UPU configuration can achieve three motion degrees of freedom: steering, cambering, and wheel hopping, and exhibits a 2R1T motion characteristic, where R represents a rotational degree of freedom and T represents a translational degree of freedom;

the upper control arm assembly corresponds to a PaU branch in the topology; and both the first servo electric cylinder 34 and the second servo electric cylinder 35 correspond to UPU branches.

Derivative structures of the topology include: PaS-2UPU, PaU-2SPU, PaU-2SPU, PaS-RPU-UPU, and PaS-2SS-UPS;

where Pa represents a parallelogram pair, S represents a spherical pair, U represents a Hooke pair, R represents a revolute pair, and P represents a prismatic pair.

Another objective of embodiments of the present application is to provide a wheel-side corner module for distributed drive electric commercial vehicles. The wheel-side corner module for distributed drive electric commercial vehicles, based on the variable-geometry suspension mechanism for distributed drive electric commercial vehicles, includes a driving structure, a braking structure, a steering structure, a cambering structure, and a suspension mechanism;

the driving structure and the braking structure are integrated to form a drive-brake integrated structure, which is arranged inside a wheel rim and, together with a tire, constitutes a wheel; and

the steering structure and cambering structure are jointly composed of the first servo electric cylinder and the second servo electric cylinder. These servo electric cylinders not only act as actuators for steering and cambering motions but also fulfill the function of the suspension linkage. The extension and retraction of the first servo electric cylinder and the second servo electric cylinder cooperatively control the attitude of the wheel.

Yet another objective of embodiments of the present application is to provide a distributed drive electric commercial vehicle. The distributed drive electric commercial vehicle, based on the wheel-side corner module for distributed drive electric commercial vehicles, includes a vehicle frame, an equipment cabin, a loading platform, and at least one wheel-side corner module; and

the wheel-side corner modules are arranged on two sides of the vehicle frame and beneath the loading platform.

Further, a plurality of the wheel-side corner module are provided.

The variable-geometry suspension mechanism and the wheel-side corner module for distributed drive electric commercial vehicles provided in the embodiments of the present application have the following beneficial effects:
(1) The suspension mechanism has three degrees of freedom: wheel hopping, steering, and wheel cambering. For the wheel hopping degree of freedom, a compound kinematic pair (parallelogram pair) is used as the upper control arm, so that the geometric kinematic characteristics of the suspension are effectively improved. For the steering degree of freedom, a wheel turning angle range of +90° to −35° can be achieved. The introduction of active camber control into the corner module significantly enhances stability and safety of the vehicles, particularly for commercial vehicles with a high center of mass. In addition, active camber adjustment can reduce tire wear, improve wheel adhesion, and compensate for track width variation.
(2) The corner module organically integrates driving, braking, steering, and suspension systems into a plug-and-play modular structure, enabling assembly and disassembly according to transport requirements and facilitating maintenance. Each corner module may be regarded as a parallel robot, with all driving functions of the chassis as well as a plurality of motion modes.
(3) The wheel-side corner module mechanism adopts a structure-function integrated design, where the steering and cambering branches serve both as driving units and as guiding linkages for the suspension, avoiding the space occupation of conventional kingpin steering units widely used in current corner modules.
(4) A face-symmetric topology is adopted, so that good isotropy is ensured.

### BRIEF DESCRIPTION OF THE DRAWINGS

FIG. 1 is a schematic diagram of the structure of a wheel-side corner module for distributed drive electric commercial vehicles according to an embodiment of the present application;

FIG. 2 is a schematic diagram of the assembly of a variable-geometry suspension mechanism for distributed drive electric commercial vehicles according to an embodiment of the present application and a wheel;

FIG. 3 is a schematic diagram of the assembly of a wheel-side corner module for distributed drive electric commercial vehicles according to an embodiment of the present application and a vehicle frame;

FIG. 4 is a schematic diagram of the exploded structure of a wheel-side corner module for distributed drive electric commercial vehicles according to an embodiment of the present application;

FIG. 5 is a schematic diagram of the structure of a chassis of a distributed drive electric commercial vehicle according to an embodiment of the present application;

FIG. 6 is a schematic diagram of the arrangement of wheel-side corner modules in a chassis of a distributed drive electric commercial vehicle according to an embodiment of the present application;

FIG. 7 is a schematic diagram of crab moving of a distributed drive electric commercial vehicle according to an embodiment of the present application;

FIG. 8 is a schematic diagram of pivot steering of a distributed drive electric commercial vehicle according to an embodiment of the present application;

FIG. 9 is a schematic diagram of diagonal moving of a distributed drive electric commercial vehicle according to an embodiment of the present application;

FIG. 10 is a schematic diagram of wheel cambering of a distributed drive electric commercial vehicle according to an embodiment of the present application to adapt to uneven road surfaces;

FIG. 11 is a schematic diagram showing wheels cambering of a distributed drive electric commercial vehicle according to an embodiment of the present application to assist vehicle steering from an outside perspective of a curve;

FIG. 12 is a schematic diagram showing wheels cambering of a distributed drive electric commercial vehicle according to an embodiment of the present application to assist vehicle steering from an inside perspective of a curve; and

FIG. 13 is a schematic diagram of coordinated transport of a box girder by a distributed drive electric commercial vehicle according to an embodiment of the present application.

Reference numerals: 100. distributed drive electric commercial vehicle; 10. wheel; 11. tire; 12. wheel rim; 20. loading platform; 21. vehicle frame; 22. equipment cabin; 30. wheel-side corner module; 31. drive-brake integrated structure; 311. first mounting seat; 312. second mounting seat; 313. third mounting seat; 314. driving structure; 315. braking structure; 32. upper control arm assembly; 321. supporting frame; 3211. fourth mounting seat; 3212. fifth mounting seat; 3213. sixth mounting seat; 3214. seventh mounting seat; 322. first control arm; 3221. first mounting hole; 3222. second mounting hole; 3223. first bushing; 3224. second bushing; 323. second control arm; 324. third control arm; 3241. eighth mounting seat; 3242. first assembly hole; 3243. second assembly hole; 33. shock absorber; 331. third assembly hole; 332. fourth assembly hole; 34. first servo electric cylinder; 341. ninth mounting seat; 342. cross shaft; 343. tenth mounting seat; 344. driving motor; 35. second servo electric cylinder; 400. sloped road surface; and 500. prefabricated box girder.

### DESCRIPTION OF EMBODIMENTS

To make the objectives, technical solutions and advantages of the present application more apparent, the present application is further described in detail below with reference to the accompanying drawings and embodiments. It should be understood that the specific embodiments described herein are merely illustrative of the present application and do not limit the present application.

Specific implementations of the present application are described in detail below with reference to specific embodiments.

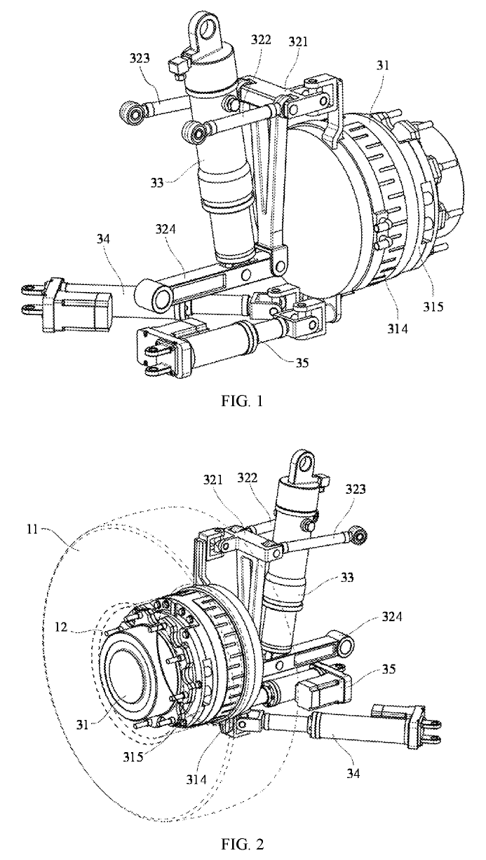

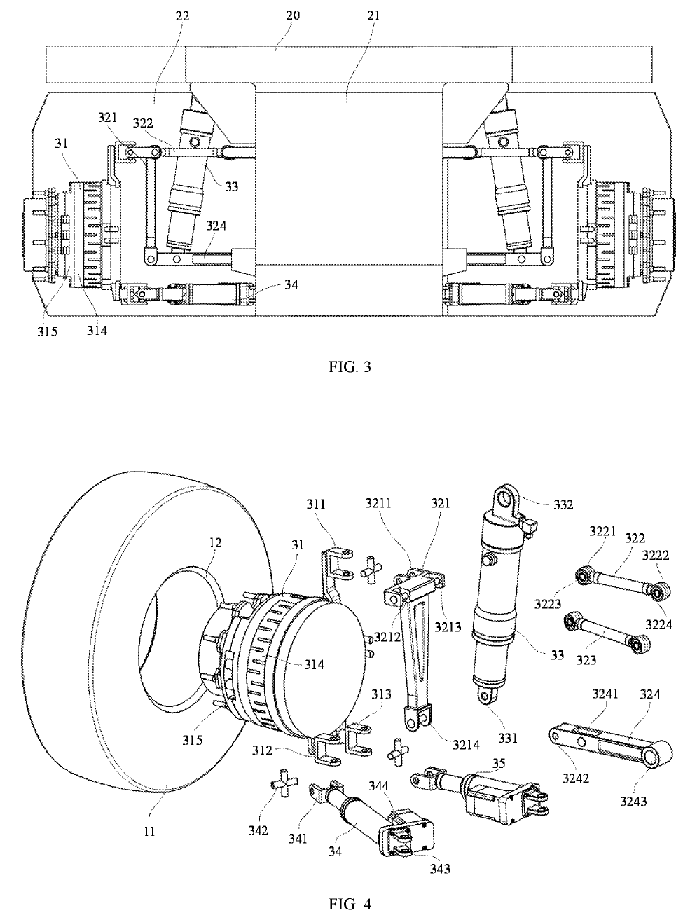

FIGS. 1 to 4 show a variable-geometry suspension mechanism for distributed drive electric commercial vehicles provided in an embodiment of the present application. The variable-geometry suspension mechanism is configured to connect a wheel 10 and a vehicle frame 21 of a distributed drive electric commercial vehicle 100, and includes:

a supporting frame 321 serving as a main framework of the suspension, where the supporting frame 321 is connected to a first mounting seat 311 on a driving and braking structure through a first mounting hole 3221 and a cross shaft;

an upper control arm assembly 32 composed of a first control arm 322, a second control arm 323, and a third control arm 324; where the first mounting hole 3221 at one end of the first control arm 322 is hinged to a sixth mounting seat 3213 on the supporting frame 321, and the other end of the first control arm is connected to the vehicle frame 21 through a second mounting hole 3222; one end of the second control arm 323 is hinged to the supporting frame 321 through a fifth mounting seat 3212, the other end of the second control arm is connected to the vehicle frame 21, and a structure of the second control arm is identical to that of the first control arm 322; one end of the third control arm 324 is connected to a seventh mounting seat 3214 on the supporting frame 321 through a first assembly hole 3242 by a revolute pair, and the other end of the third control arm is connected to the vehicle frame 21 through a second assembly hole 3243 by a revolute pair;

a shock absorber 33, where one end of the shock absorber is connected to an eighth mounting seat 3241 on the third control arm 324 through a third assembly hole 331, and the other end of the shock absorber is connected to the vehicle frame 21 through a fourth assembly hole 332 for absorbing wheel vibrations;

a first servo electric cylinder 34 and a second servo electric cylinder 35 serving as lower control arms of the suspension and also having steering and cambering drive functions; where one end of the first servo electric cylinder 34 is provided with a ninth mounting seat 341, the ninth mounting seat 341 is connected to a second mounting seat 312 of a drive-brake integrated structure 31 through a cross shaft 342, the other end of the first servo electric cylinder 34 is rotatably connected to the vehicle frame 21 through a tenth mounting seat 343, and a driving motor 344 in the first servo electric cylinder 34 performs driving control; and a structure of the second servo electric cylinder 35 is similar to that of the first servo electric cylinder 34, one end of the second servo electric cylinder is connected to a third mounting seat 313 of the drive-brake integrated structure 31, the other end of the second servo electric cylinder is connected to the vehicle frame 21, and both the first servo electric cylinder and the second servo electric cylinder jointly control the steering and cambering motions of the wheel.

In an embodiment of the present application, to satisfy the maneuverability requirement of a 90° steering angle of the wheel, the dimensions and hardpoints of the first servo electric cylinder 34 and the second servo electric cylinder 35 are arranged as shown in FIG. 1. Specifically, an included angle between the first servo electric cylinder 34 and a forward direction of a longitudinally vertical symmetry plane of the vehicle is 86°, and an included angle between the second servo electric cylinder 35 and the forward direction of the longitudinally vertical symmetry plane of the vehicle is 50°.

The mechanism follows a structure-function integrated design method, where the first servo electric cylinder 34 and the second servo electric cylinder 35 serve both as driving units for the steering and cambering degrees of freedom of the wheel 10 and as guiding linkages of the suspension to constrain vertical motion of the wheel. Taking the first servo electric cylinder 34 as an example, the second mounting seat 312 of the drive-brake integrated structure 31 is connected to the ninth mounting seat 341 of the first servo electric cylinder 34 by the cross shaft 342.

As shown in FIG. 4, in a preferred embodiment of the present application, the variable-geometry suspension mechanism for distributed drive electric commercial vehicles further includes a first bushing 3223 and a second bushing 3224, both of which are elastic elements.

One end of the first control arm 322 is hinged to the sixth mounting seat 3213 on the supporting frame 321 via the first mounting hole 3221 and the first bushing 3223, and the other end of the first control arm is hinged to the vehicle frame 21 via the second mounting hole 3222 and the second bushing 3224.

The second control arm 323 is connected in the same manner as the first control arm 322.

In the embodiment of the present application, the bushings and the mounting holes may be tightly fitted together through a pressing manner so as to prevent relative movement therebetween, thereby enabling vibration and impact to be absorbed through the bushings.

In a preferred embodiment of the present application, the shock absorber 33 may be a shock absorber 33 in the prior art. Specifically, the shock absorber 33 may be a single-tube shock absorber or a double-tube shock absorber, and the elastic element may adopt structural forms such as an air spring, a coil spring, or an oil-gas spring. A specific structure of the shock absorber is not further described in the present application.

In a preferred embodiment of the present application, a topology of the suspension mechanism is a PaU-2UPU configuration, and the PaU-2UPU configuration can achieve three motion degrees of freedom: steering, cambering, and wheel hopping, and exhibits a 2R1T motion characteristic, where R represents a rotational degree of freedom and T represents a translational degree of freedom;

the upper control arm assembly corresponds to a PaU branch in the topology; and both the first servo electric cylinder 34 and the second servo electric cylinder 35 correspond to UPU branches.

Derivative structures of the topology include: PaS-2UPU, PaU-2SPU, PaU-2SPU, PaS-RPU-UPU, and PaS-2SS-UPS;

FIGS. 1 to 4 show a wheel-side corner module for distributed drive electric commercial vehicles provided in another embodiment of the present application. The wheel-side corner module for distributed drive electric commercial vehicles includes: a driving structure, a braking structure, a steering structure, a cambering structure, and the suspension mechanism.

The driving structure and the braking structure are integrated to form a drive-brake integrated structure 31, which is disposed inside a wheel rim and cooperates with a tire 11 to constitute a wheel 10. A driving system in the drive-brake integrated structure 31 adopts an in-wheel motor as a power source, and the drive-brake integrated structure 31 serves as a steering knuckle within a wheel-side corner module 30. Specifically, one end of an upper control arm assembly 32, a first servo electric cylinder 34, and a second servo electric cylinder 35 is hinged to a vehicle frame 21, and another end thereof is hinged to the drive-brake integrated structure 31, forming a force transmission path from a ground reaction force applied to the tire to the vehicle frame.

The steering structure and the cambering structure are designed integrally with the suspension mechanism. The steering structure and the cambering structure are jointly composed of the first servo electric cylinder 34 and the second servo electric cylinder 35, and the first servo electric cylinder 34 and the second servo electric cylinder 35 are integrally designed. The first servo electric cylinder 34 and the second servo electric cylinder 35 function not only as actuators for steering and cambering motions but also as guiding linkages of the suspension mechanism. The extension and retraction of the first servo electric cylinder 34 and the second servo electric cylinder 35 cooperatively control the attitude of the wheel 10.

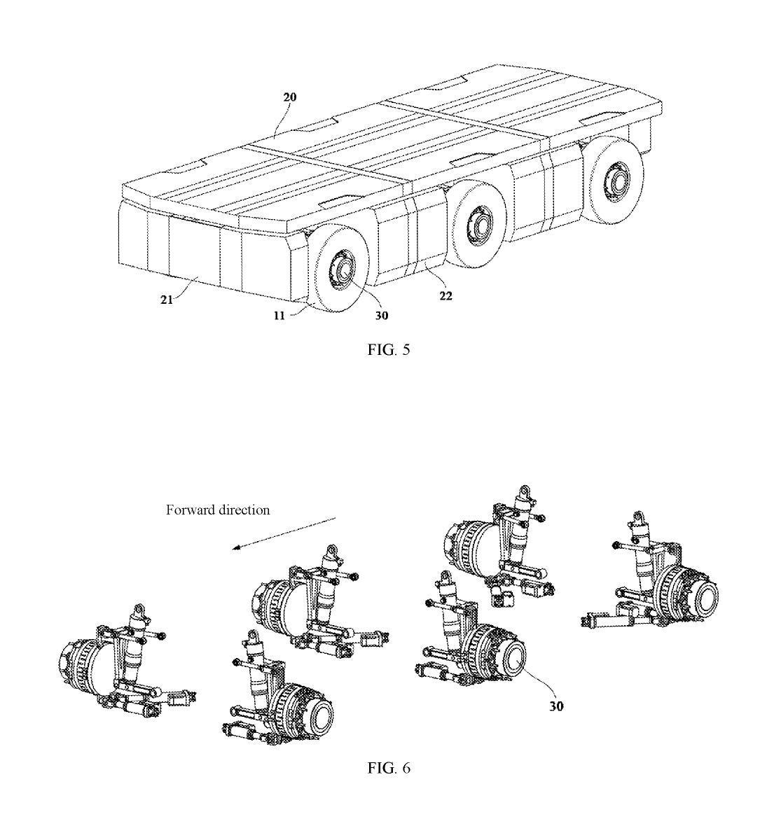

FIGS. 5 and 6 show a distributed drive electric commercial vehicle provided in another embodiment of the present application. The distributed drive electric commercial vehicle includes a vehicle frame 21, an equipment cabin 22, a loading platform 20, and at least one wheel-side corner module 30.

The wheel-side corner modules 30 are arranged on two sides of the vehicle frame 21 and beneath the loading platform 20.

In a preferred embodiment of the present application, the distributed drive electric commercial vehicle is a three-axle distributed drive electric commercial vehicle, which includes six wheel-side corner modules 30, a vehicle frame 21, a cargo loading platform 20 covering the vehicle frame, and equipment cabins 22 distributed between the wheel-side corner modules 30.

The suspension structure is configured to connect a wheel 10 and the vehicle frame 21, to transmit a force received by the wheel to the vehicle frame and further to an entire vehicle body, and simultaneously to output an appropriate wheel-end motion trajectory.

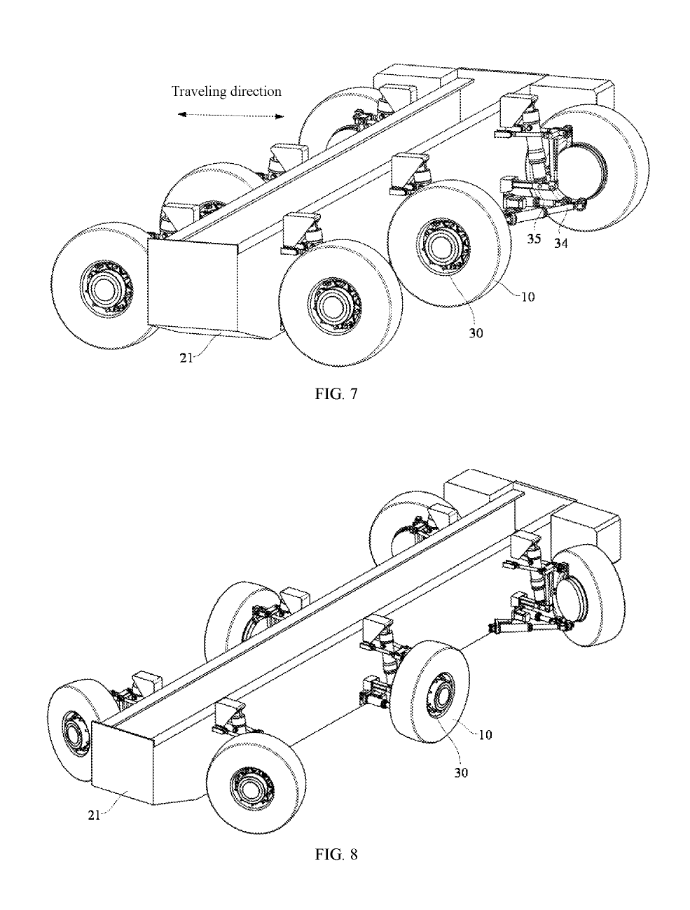

As shown in FIG. 7, crab moving locomotion enables the vehicle to be conveniently parked in a narrow space, which is particularly important for commercial vehicles operating in urban environments. In this embodiment, the corner module system 30 has an independent steering function and is capable of achieving a steering angle range of +90° to −35°. To enable the vehicle to perform crab moving, the corner module mechanisms corresponding to a front axle and a middle axle of the distributed drive electric commercial vehicle 100 drive the wheels to rotate 90° toward a front end of the vehicle, and the corner module mechanism corresponding to a rear axle drives the wheels to rotate 90° toward a rear end of the vehicle. During steering, the first servo electric cylinder 34 extends and the second servo electric cylinder 35 contracts, causing the wheel 10 composed of the drive-brake integrated structure 31 and the tire 11 to rotate counterclockwise.

As shown in FIG. 8, pivot steering, also referred to as zero-radius steering, enables the vehicle to rapidly change the direction within a confined space. To enable the vehicle to perform the pivot steering locomotion, the corner module mechanisms corresponding to the front axle and the rear axle of the distributed drive electric commercial vehicle 100 drive the wheels to turn inward, such that steering centers of four wheels fall on the middle axle. The corner modules corresponding to a middle axle do not perform steering motion and only perform differential driving through the driving system.

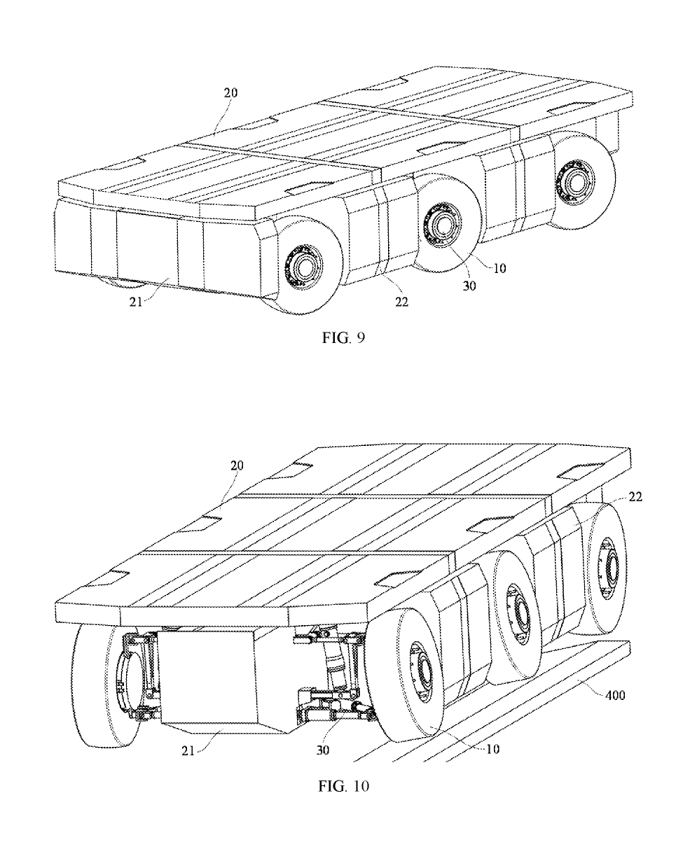

As shown in FIG. 9, a diagonal moving maneuver is advantageous for collision avoidance during high-speed driving. In this motion mode, all corner modules drive the wheels to rotate by the same angle in the same direction, thereby enabling a change in the driving direction of the vehicle without changing the orientation of the vehicle front end.

As shown in FIG. 10, transportation tasks of commercial vehicles are often confronted with unstructured terrains, where it is necessary to adjust the degrees of freedom of each wheel to maintain the vehicle body in a level state and keep the tires in contact with the ground. The active camber angle adjustment function of the variable-geometry suspension mechanism enables the vehicle to adapt to a sloped road surface 400.

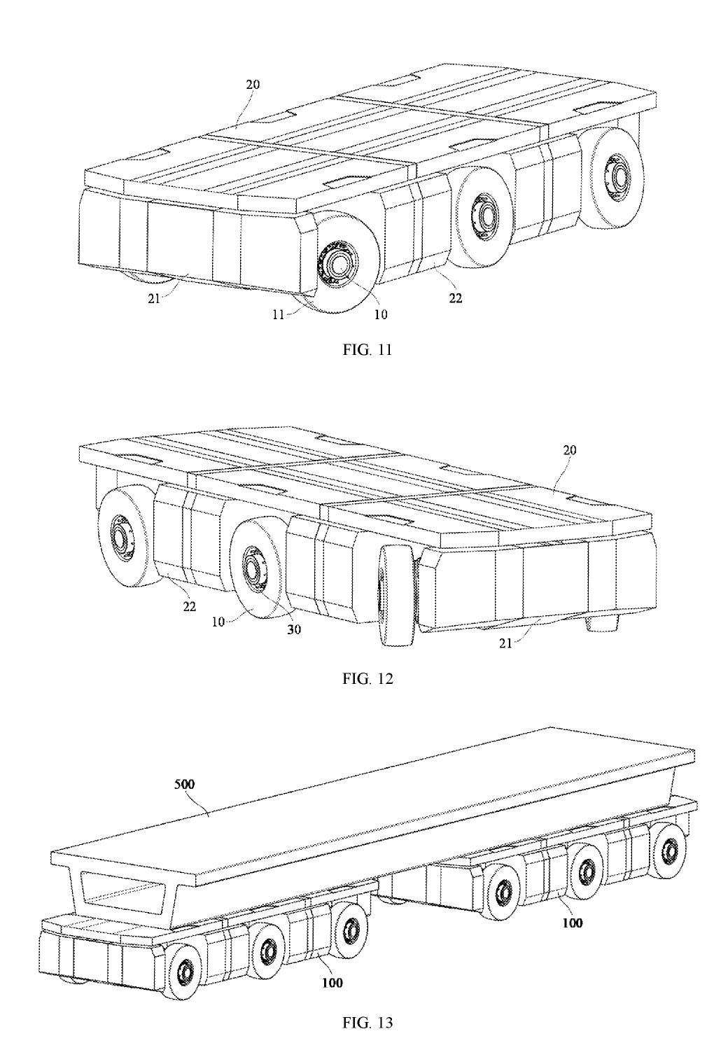

FIGS. 11 and 12 show a motion mode in which an active camber of the wheel assists vehicle steering. Under cornering conditions, inclining the wheel toward an inside of a curve by a certain angle provides additional lateral force and simultaneously reduces a demand for a steering angle of the wheel. For multi-axle commercial vehicles, a reasonable configuration of wheel cambering can reduce a roll angle, a lateral load transfer rate, and a centroid sideslip angle, thereby effectively lowering a rollover risk of the vehicle. In this embodiment, corner modules corresponding to a front axle of the distributed drive electric commercial vehicle perform steering motion, and corner modules corresponding to a middle axle and a rear axle perform cambering motion, with wheels on both sides cambering in the same direction, all inclined toward an inside of the curve. In this configuration, a yaw response of the vehicle shows little variation compared with that of a configuration without camber, while a centroid sideslip angle is significantly reduced. The above characteristics facilitate decoupling control of yaw angular velocity and sideslip angle for multi-axle vehicles.

A combination of a plurality of the distributed drive electric commercial vehicles 100 can effectively expand a size and weight range of transported cargo. The transported cargo may include prefabricated box girder components, large wind turbine blades, large pressure vessels, and large power grid transformers. FIG. 13 shows an embodiment in which two distributed drive electric commercial vehicles 100 cooperatively transport a box girder 500. In addition, by changing a number of axles of the distributed drive electric commercial vehicle and a number of chassis participating in the transportation, a configuration of the vehicles participating in the transportation can be arranged according to a size of the transported cargo.

The above mentioned contents are only preferred embodiments of the present application and are not intended to limit the present application. Any modification, equivalent substitution, improvement and the like made within the spirit and principle of the present application shall all fall within the scope of protection of the present application.

What is claimed is:

1. A variable-geometry suspension mechanism for distributed drive electric commercial vehicles, configured to connect a wheel to a vehicle frame of the distributed drive electric commercial vehicle, comprising: a supporting frame, an upper control arm assembly, a first servo electric cylinder, a second servo electric cylinder, and a shock absorber; wherein
the upper control arm assembly comprises a first control arm, a second control arm, and a third control arm, and is located on one side of the supporting frame; one end of the upper control arm assembly is hinged to a drive-brake integrated structure, and the other end of the upper control arm assembly is hinged to the vehicle frame;
the first servo electric cylinder and the second servo electric cylinder function as lower control arms of the suspension and as driving units for steering and cambering motions; one end of each of the first servo electric cylinder and the second servo electric cylinder is hinged to the drive-brake integrated structure, and the other end of each of the first servo electric cylinder and the second servo electric cylinder is hinged to the vehicle frame; and
one end of the shock absorber is hinged to the third control arm, and the other end of the shock absorber is hinged to the vehicle frame.

2. The variable-geometry suspension mechanism for distributed drive electric commercial vehicles according to claim 1, further comprising a first bushing and a second bushing, wherein both the first bushing and the second bushing are elastic elements;
one end of the first control arm is hinged to a sixth mounting seat on the supporting frame via a first mounting hole and the first bushing, and the other end of the first control arm is hinged to the vehicle frame via a second mounting hole and the second bushing; and
the second control arm is connected in the same manner as the first control arm.

3. The variable-geometry suspension mechanism for distributed drive electric commercial vehicles according to claim 1, wherein a topology of the suspension mechanism is a PaU-2UPU configuration, Pa represents a parallelogram pair, U represents a Hooke pair, and P represents a prismatic pair; and the PaU-2UPU configuration achieves three motion degrees of freedom: steering, cambering, and wheel hopping, and exhibits a 2R1T motion characteristic, R represents a rotational degree of freedom, and T represents a translational degree of freedom;
the upper control arm assembly corresponds to a PaU branch in the topology; and both the first servo electric cylinder and the second servo electric cylinder correspond to UPU branches.

4. The variable-geometry suspension mechanism for distributed drive electric commercial vehicles according to claim 3, wherein derivative structures of the topology comprise: PaS-2UPU, PaU-2SPU, PaU-2SPU, PaS-RPU-UPU, and PaS-2SS-UPS;
wherein Pa represents a parallelogram pair, S represents a spherical pair, U represents a Hooke pair, R represents a revolute pair, and P represents a prismatic pair.

5. A wheel-side corner module for distributed drive electric commercial vehicles, based on the variable-geometry suspension mechanism for distributed drive electric commercial vehicles according to claim 1, comprising: a driving structure, a braking structure, a steering structure, a cambering structure, and a suspension mechanism; wherein
the driving structure and the braking structure are integrated to form a drive-brake integrated structure, and the drive-brake integrated structure is arranged inside a wheel rim and, together with a tire, constitutes a wheel;
the steering structure and cambering structure are jointly composed of the first servo electric cylinder and the second servo electric cylinder; these servo electric cylinders not only act as actuators for steering and cambering motions but also fulfill the function of the suspension linkage; and the extension and retraction of the first servo electric cylinder and the second servo electric cylinder cooperatively control the attitude of the wheel.

6. A distributed drive electric commercial vehicle, based on the wheel-side corner module for distributed drive electric commercial vehicles according to claim 5, comprising: a vehicle frame, an equipment cabin, a loading platform, and at least one wheel-side corner module; wherein
the wheel-side corner modules are arranged on two sides of the vehicle frame and beneath the loading platform.

7. The distributed drive electric commercial vehicle according to claim 6, wherein a plurality of the wheel-side corner module are provided.
